(19) United States
(12) Patent Application Publication
(10) Pub. No.: US 2026/0228416 A1
(43) Pub. Date: Aug. 6, 2026

(54) SYSTEM AND METHOD FOR MULTIMEDIA SHARING AND EMBEDDING

(71) Applicant: Aiera Inc., New York, NY (US)

(72) Inventors: Elliot Nash, Pelham, NH (US); Michael Michaelevich, Wymouth, MA (US); Ken Sena, Litchfield, CT (US); Bryan Healey, Malden, MA (US)

(21) Appl. No.: 19/043,175

(22) Filed: Jan. 31, 2025

(51) Int. Cl. G06F 40/12; G06F 3/04842; G06F 3/16

(52) U.S. Cl. CPC G06F 40/12; G06F 3/04842; G06F 3/165

(57) ABSTRACT

A system includes a user device having a user device processor configured to generate a user interface and a server having a server-side processor and a memory storing instructions that define an algorithm for managing audio-text synchronization. The system is configured to store audio data and transcribed text and execute the stored algorithm. The server-side processor transmits to the user device processor, transcribed text and audio data including a transcribed text and a corresponding audio segment. The system generates, on the user device, a user interface configured to display the transcribed text, and enables a selection mechanism through which a user selects a portion of the transcribed text. The system includes synchronize, via an audio processing unit, the selected portion of the transcribed text with the corresponding audio segment and generating shareable content that combines the selected portion of the transcribed text and the corresponding audio segment.

### CROSS-REFERENCE TO RELATED APPLICATIONS

This application claim priority to, and the benefit of, U.S. Provisional Patent Application No. 64,171,107, filed Feb. 1, 2024, the entire contents of which are hereby incorporated herein.

### FIELD OF INVENTION

The present disclosure relates to multimedia sharing and embedding systems, and more particularly to a system for creating and sharing interactive audio-text snippets from transcribed audio content.

### BACKGROUND

In the rapidly evolving domain of financial investments, efficient and effective communication is paramount. A significant aspect of this communication involves the sharing of quotes and sound bites from transcribed audio, a practice that is not exclusive to, but particularly prevalent in, the financial sector. This process, however, is fraught with challenges and limitations in its current state.

Presently, when individuals seek to share a specific quote, their primary recourse is to manually extract text from an existing transcript. This method, while straightforward, strips away the rich, nuanced layers embedded in the original audio. The tonal subtleties, the speaker's emphasis, and the inherent emotional weight carried in the voice are irretrievably lost in plain text. These elements are often crucial, especially in the context of financial discourse, where the inflection and conviction in a speaker's voice can heavily influence the interpretation and perceived credibility of the information.

An alternative approach involves linking to the entire audio or video source, such as a timestamped segment on a platform like YouTube. While this method retains the audio component, it introduces significant inefficiencies. Users are compelled to navigate away from their initial context to access the content, a process that is both time-consuming and disruptive. This inefficiency is particularly detrimental in the investment landscape, where timely access to information can be the difference between a profitable decision and a missed opportunity.

A more direct solution involves individuals recording the desired audio segment using personal devices. However, this approach raises practical concerns regarding the ease of sharing and accessing these recordings. The process is cumbersome, and the lack of a streamlined method for pairing these recordings with their corresponding textual transcripts further complicates matters.

The current methodologies for sharing transcribed audio quotes in the financial investment sector, and beyond, are inadequate. They either fail to capture the full depth of the original audio or impose impractical burdens on both the sharer and the recipient. There is a clear and pressing need for an innovative solution that can encapsulate the richness of audio communication while ensuring ease of access and sharing, a solution that acknowledges the critical role of time-efficiency in the fast-paced world of financial decision-making.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In some aspects, the techniques described herein relate to a system for embedding transcribed audio in a document, including a user device including a user device electronic processor. The user device electronic processor is configured to generate a user interface. The system includes server including a server-side electronic processor and a memory storing computer-executable instructions that define an algorithm for managing audio-text synchronization, the server-side electronic processor communicatively coupled to the server, the user device, and the memory. The server is configured to store audio data and transcribed text, and the server-side electronic processor is configured to execute the stored algorithm and thereby cause the system to transmit, to the user device electronic processor, transcribed text and audio data including a transcribed text and a corresponding audio segment, generate, on the user device, via the user device electronic processor, a user interface configured to display the transcribed text, enable, via the user device electronic processor, a selection mechanism through which a user selects a portion of the transcribed text; synchronize, via an audio processing unit, the selected portion of the transcribed text with the corresponding audio segment, generate, via an embedding module, shareable content that combines the selected portion of the transcribed text and the corresponding audio segment; and display, on the user interface of the user device, the shareable content.

In some aspects, the techniques described herein relate to a system, wherein the user interface is configured to display the transcribed text and corresponding audio waveform. In some aspects, the techniques described herein relate to a system, wherein the selection mechanism is configured to allow the user to select the portion of the transcribed text by highlighting text or specifying start and end points.

In some aspects, the techniques described herein relate to a system, wherein the audio processing unit is configured to extract the corresponding audio segment based on timestamps associated with the selected portion of the transcribed text. In some aspects, the techniques described herein relate to a system, wherein the embedding module includes an embedding functionality configured to generate an embeddable code snippet for inserting the shareable content into a web page or document.

In some aspects, the techniques described herein relate to a system, wherein the embeddable code snippet includes JavaScript for rendering an interactive player displaying the selected portion of the transcribed text and controls for playing the corresponding audio segment. In some aspects, the techniques described herein relate to a system, wherein the interactive player is configured to highlight words in the displayed transcribed text as they are spoken in an audio playback.

In some aspects, the techniques described herein relate to a method for embedding transcribed audio in a document, including: storing, in a server memory accessible by a server-side electronic processor, audio data and transcribed text corresponding to the audio data; communicating, from the server-side electronic processor to a user device electronic processor, the transcribed text and corresponding audio data; providing, on the user device, via the user device electronic processor, a user interface configured to display the transcribed text; receiving, via the user interface, a user selection of a portion of the transcribed text; synchronizing, via an audio processing unit, the selected portion of the transcribed text with a corresponding audio segment; generating, via an embedding module, shareable content that combines the selected portion of the transcribed text and the corresponding audio segment; and displaying, on the user interface of the user device, the shareable content.

In some aspects, the techniques described herein relate to a method, further including displaying a waveform representation of the audio segment alongside the transcribed text in the user interface. In some aspects, the techniques described herein relate to a method, wherein receiving the user selection includes detecting a highlighting action performed by the user on the transcribed text.

In some aspects, the techniques described herein relate to a method, wherein synchronizing the selected portion of the transcribed text with the corresponding audio segment includes: identifying timestamps associated with the selected portion of the transcribed text; and extracting the corresponding audio segment based on the identified timestamps. In some aspects, the techniques described herein relate to a method, wherein generating the shareable content includes creating an embeddable code snippet for inserting the shareable content into a web page or document.

In some aspects, the techniques described herein relate to a method, wherein the embeddable code snippet includes JavaScript for rendering an interactive player displaying the selected portion of the transcribed text and controls for playing the corresponding audio segment. In some aspects, the techniques described herein relate to a method, wherein the interactive player is configured to highlight words in the displayed transcribed text as they are spoken during playback of the corresponding audio segment.

In some aspects, the techniques described herein relate to a non-transitory computer-readable medium storing instructions that, when executed by one or more processors, cause the one or more processors to perform operations for embedding transcribed audio in a document, the operations including: storing, in a server memory accessible by a server-side electronic processor, audio data and corresponding transcribed text; communicating, from the server-side electronic processor to a user device electronic processor, the transcribed text and the corresponding audio data; providing, via the user device electronic processor, a user interface on the user device, wherein the user interface is configured to display the transcribed text; receiving, via the user interface, a user selection of a portion of the transcribed text; synchronizing, via an audio processing unit, the selected portion of the transcribed text with a corresponding audio segment; generating, via an embedding module, shareable content that combines the selected portion of the transcribed text with the corresponding audio segment; and displaying, on the user interface of the user device, the shareable content.

In some aspects, the techniques described herein relate to a non-transitory computer-readable medium, wherein the operations further include displaying a waveform representation of the audio segment alongside the transcribed text in the user interface. In some aspects, the techniques described herein relate to a non-transitory computer-readable medium, wherein receiving the user selection includes detecting a highlighting action performed by the user on the transcribed text.

In some aspects, the techniques described herein relate to a non-transitory computer-readable medium, wherein synchronizing the selected portion of the transcribed text with the corresponding audio segment includes: identifying timestamps associated with the selected portion of the transcribed text; and extracting the corresponding audio segment based on the identified timestamps. In some aspects, the techniques described herein relate to a non-transitory computer-readable medium, wherein generating the shareable content includes creating an embeddable code snippet for inserting the shareable content into a web page or document.

In some aspects, the techniques described herein relate to a non-transitory computer-readable medium, wherein the embeddable code snippet includes JavaScript for rendering an interactive player displaying the selected portion of the transcribed text and controls for playing the corresponding audio segment, and wherein the interactive player is configured to highlight words in the displayed transcribed text as they are spoken during playback of the corresponding audio segment.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a system for embedding transcribed audio in documents, according to aspects of the present disclosure.

FIG. 2 illustrates a block diagram of a multimedia sharing and embedding system, in accordance with example embodiments.

FIG. 3 illustrates a block diagram of a multimedia embedding system with a web interface environment, according to an embodiment.

FIG. 4 illustrates a block diagram of a multimedia sharing and embedding system with content manipulation options, according to aspects of the present disclosure.

FIG. 5 illustrates a process of a multimedia sharing and embedding system, in accordance with example embodiments.

### DETAILED DESCRIPTION

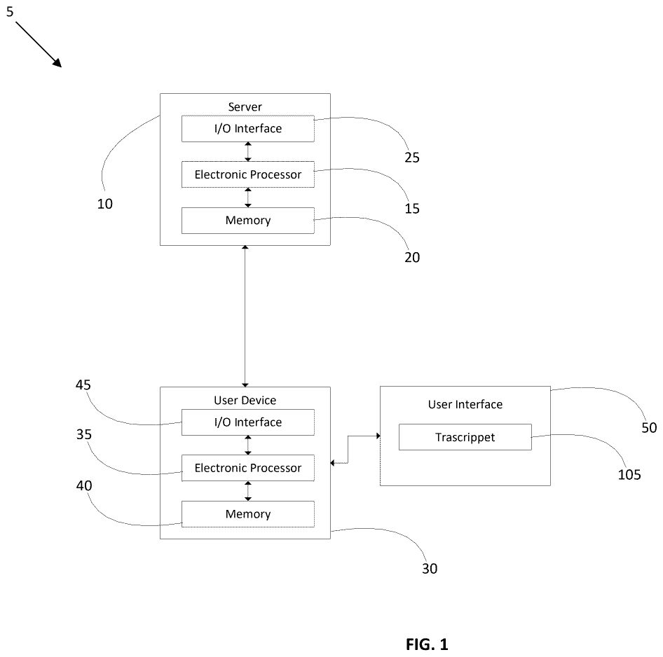

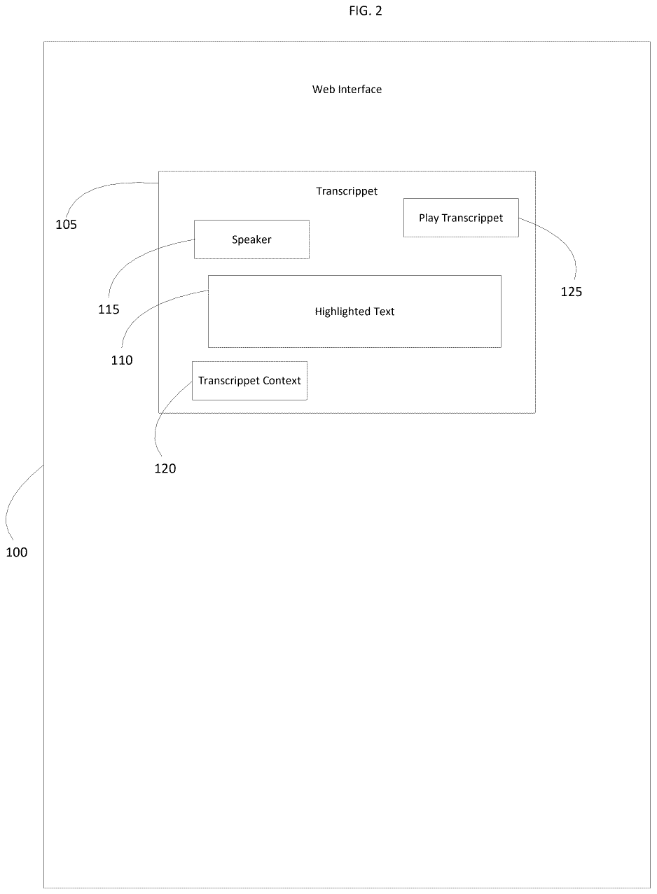

FIG. 1 describes a multimedia sharing and embedding system 5. The multimedia sharing and embedding system 5, as illustrated in FIG. 1, comprises a server system 10 and a user device 30 that communicate with each other. The server system 10 (also referred to as a server) may include a server I/O (input/output) interface 25, a server electronic processor 15 (also referred to as a server-side electronic processor), and a server memory 20. The user device 30 may include a user device I/O interface 45, a user device electronic processor 35, user device memory 40, and a user interface 50. Within the user interface 50, a transcription module 105 may operate to handle the selection, processing, and display of transcribed audio content. This transcription module 105 may interact with other components through the user device electronic processor 35 to synchronize text selections with corresponding audio segments. The transcription module 105 is used to present Transcrippets™ to the user. The Transcrippets™ are described in greater detail below and with respect to FIGS. 2-5.

As shown in FIG. 1, the server system 10 includes the server I/O interface 25, a server electronic processor 15, and a server memory 20. In some examples, the server electronic processor 15 is implemented as a microprocessor with separate memory, for example the server memory 20. In other examples, the server electronic processor 15 may be implemented as a microcontroller (with server memory 20 on the same chip). In other examples, the server electronic processor 15 may be implemented using multiple processors. In addition, the server electronic processor 15 may be implemented partially or entirely as, for example, a field-programmable gate array (FPGA), an applications specific integrated circuit (ASIC), and the like and the server memory 20 may not be needed or be modified accordingly. In some examples detailed herein, the server memory 20 includes non-transitory, computer-readable memory that stores computer-executable instructions that are received and executed by the server electronic processor 15 to carry out processes described herein including methods of road surface detection. The server memory 20 may include, for example, a program storage area and a data storage area. The program storage area and the data storage area may include combinations of different types of memory, for example read-only memory and random-access memory. The server I/O interface 25 may include one or more input mechanisms and one or more output mechanisms (for example, general-purpose input/outputs (GPIOs), a controller area network bus (CAN) bus interface, analog inputs digital inputs, and the like). In some examples, the user device I/O interface 45, the user device electronic processor 35, and the user device memory 40 are like their server-side counterparts.

As shown in FIG. 2, the system 5 may include several interconnected components. The system interface 100 may provide access to various system components. The transcription module 105 may serve as the main component for processing and displaying multimedia content. The text selection module 110 may enable selection and management of text portions from transcripts. The audio processor 115 may process the audio components of the content. The synchronization module 120 may coordinate the timing between text and audio elements. The playback interface 125 may provide controls for playing and interacting with the combined audio-text content.

In some examples, users may highlight or specify a segment of the transcribed text within the interface, prompting the system 5 to optionally identify the matching audio clip through its underlying algorithms. Once identified, the user is presented with the audio elements that accompany the selected text. Multiple speakers may be visually distinguished (i.e., using highlight colors, font types, or other visually distinct elements), allowing for selective capture of dialogue or commentary from specific individuals. The transcription module 105 offers the choice to trim, splice, or otherwise edit segments before packaging them for sharing or embedding. Once prepared, each snippet may be saved or exported as a discrete audio-text unit, complete with any desired enhancements or formatting.

The audio components encompass any type of sound content, including speech from one speaker, dialogue between two speakers, music and/or sound effects. For speech-based recordings, the transcription module 105 may handle monologues or multi-speaker conversations, recognizing and highlighting distinct voices and mapping them to separate transcript sections. Ambient noise or background tracks, such as intro music for a podcast or sound effects, may also be incorporated by the transcription module 105 to highlight key moments. The transcription module 105 audio processing enables these audio components to remain synchronized with the corresponding text, including, for example, a single voice-over, multiple speakers conversing, and/or supplementary audio enhancements. For example, a news organization might combine an anchor's narrative with recorded sound bites from interviews or live events, then embed everything into a cohesive Transcrippet™ that stays in sync regardless of how many audio elements are present. In another example, a Transcrippet™ about a company quarterly financial report may include a financial officer speaking about product performance with a Transcrippet™ including an embedded company stock performance.

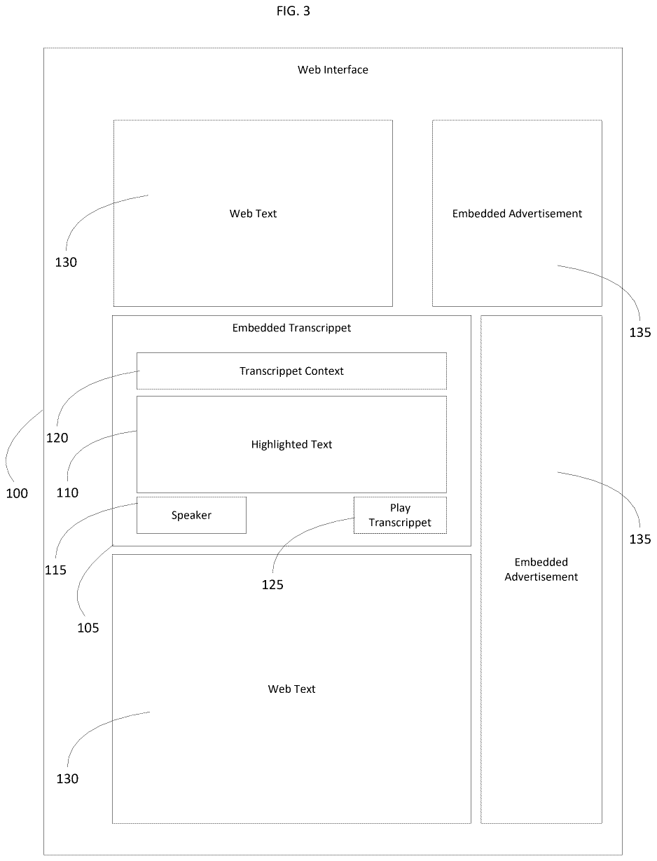

FIG. 3 is a system interface 100, illustrating how transcription module 105 may be integrated into an interface environment (e.g., a website or a document). The system interface 100 may provide a web-based platform for displaying and interacting with the content of a Transcrippet™. Within this interface, the content display area 130 may show both the original web text and the embedded transcrippet content, including highlighted text and speaker information. Speaker information may include details about the individual (or individuals) who appears in an audio recording. For example, the speaker's full name, job title, or company role, may be included in the Transcrippet™ ensuring that listeners can quickly identify the source of a comment. Additional details might include the speaker's affiliation (e.g., department or organization), contact information, or a link to an online profile. In some examples, more personalized metadata is stored, such as a brief bio, a photograph, or voice characteristics (like pitch range, accent, spoken languages, or the like) to offer deeper context. The speaker information provides details for users of the Transcrippet™ to distinguish between multiple speakers and identify who is contributing to the audio. The text selection module 110 may enable users to select and highlight specific portions of text within the content display area 130.

Once a selection is made, the audio processor 115 processes the audio components associated with the selected text. The synchronization module 120 may then coordinate the timing between the displayed text and audio playback. In some examples, the timing between displayed text and audio playback is handled by associating each word or segment of text with a precise timestamp. For example, when the audio is transcribed by the transcription module 105, the system 5 uses time-based markers generated during the transcription process to link specific words or lines to exact moments in the audio track. As playback progresses, the user interface references these timestamps to highlight or scroll the matching text in real time. The synchronization ensures that when the audio reaches a particular speaker phrase or sentence, the displayed text is updated. In some examples, the system 5 may use a post-processing alignment algorithm to synchronize the text and audio elements of the Transcrippet™.

The playback interface 125 may provide controls for playing and pausing the audio content associated with the selected text. This interface may be positioned below the text selection area for easy access to audio controls. In some cases, the system 5 may include an advertisement module 135 that manages the display of embedded advertisements within designated areas of the interface. These advertisements may appear in multiple locations within the system interface 100.

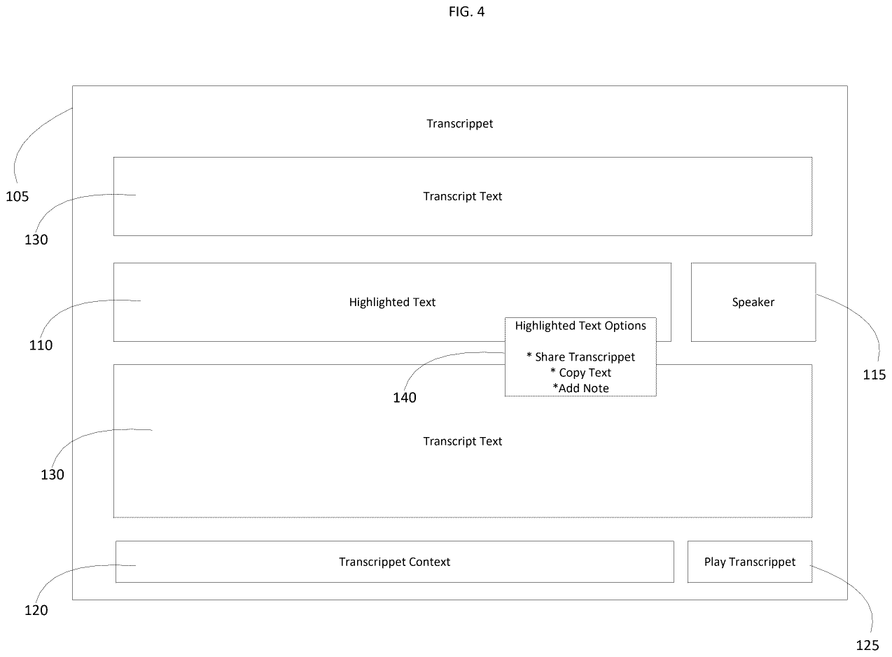

FIG. 4 provides a more detailed view of the transcription module 105 and its associated components. The options menu 140 may provide functionality for sharing and manipulating the selected content, including options to share the transcrippet, copy text, and add notes. Users can personalize the font, color scheme, and overall layout to reflect individual preferences or meet specific brand guidelines. The embedded player also features cohesive styling options to maintain a consistent look and feel across different platforms. Beyond visual customization, the system offers advanced audio processing features, including noise reduction, speaker diarization, and voice enhancement, all designed to improve audio playback quality for Transcrippets™. Moreover, the system supports multiple languages, ensuring users can create and share Transcrippets™ in various languages and even access translation for both text and audio.

In some cases, the system 5 may integrate with popular content management systems (CMS) and social media platforms. Users can directly post Transcrippets™ to websites, blogs, or social media accounts without leaving the creation interface. Additionally, the system incorporates collaborative features that let multiple contributors work together when editing and refining Transcrippets™. This collaboration includes shared workspaces, version control, and the ability to add comments or annotations on specific segments.

The system 5 may offer collaborative features that allow multiple users to work on creating and editing Transcrippets™. This may include shared workspaces, version control, and the ability to leave comments or annotations on specific parts of a Transcrippet™. In some implementations, the system 5 may provide advanced search functionality within Transcrippets™. For example, the system 5 provides robust search capabilities within Transcrippets™, enabling users to locate particular words or phrases and immediately jump to matching audio segments. It also integrates with popular notetaking and productivity tools, so individuals can export full Transcrippets™ or selected parts into their preferred organizational platforms. By seamlessly combining audio transcription, customization, collaboration, and integration, the system significantly enhances content creation and information management workflows.

The system 5 provides a range of accessibility features to ensure that Transcrippets™ serve individuals with diverse needs. It integrates seamlessly with screen readers, offers streamlined keyboard navigation, and allows users to modify both playback speed and text size. These enhancements create an inclusive environment where everyone can interact comfortably with the Transcrippets™.

Beyond basic engagement metrics, the system 5 extends its analytics and reporting capabilities to deliver deeper insights into audio content. It includes sentiment analysis that gauges the emotional tone of discussions, speaker performance metrics that track clarity and pacing, and topic modeling that uncovers recurring themes or subjects in Transcrippets™. These analytics tools empower users to better understand, evaluate, and refine their content.

In some implementations, the system 5 may support the creation of playlists or collections of Transcrippets™. This feature may allow users to curate and share multiple related Transcrippets™ as a single package, enhancing the storytelling and information sharing capabilities of the platform. The system may provide options for scheduling the publication or sharing of Transcrippets™. This feature may allow users to prepare Transcrippets™ in advance and set them to be automatically shared at specific times, which may be particularly useful for coordinating communication strategies or marketing campaigns.

In some cases, the system 5 may offer integration with customer relationship management (CRM) systems. This integration may allow users to associate Transcrippets™ with specific customer records, enhancing the ability to track and manage customer communications and interactions. The system may provide options for creating interactive Transcrippets™. These may include the ability to add clickable hyperlinks within the transcribed text, embed additional media such as images or charts, or create branching narratives where users can choose different paths through the audio content.

For example, the system 5 supports the creation of playlists or collections of Transcrippets™, enabling users to group related snippets and share them as a cohesive set. This curated approach enriches the audience's experience by presenting multiple perspectives or elements of a topic in one package. Additionally, the system provides scheduling options for publishing or sharing Transcrippets™. Users can prepare Transcrippets™ in advance, set them to go live at specific times, and coordinate their communication strategies or marketing campaigns more effectively.

In some implementations, the system 5 may offer machine learning capabilities to improve transcription accuracy over time. The system may learn from user corrections and adjustments to continually refine its transcription algorithms, resulting in increasingly accurate Transcrippets™. The system may provide options for creating and managing templates for Transcrippets™. The system 5 may provide options for creating multi-speaker Transcrippets™. These may include visual differentiation between speakers in the transcribed text, as well as the ability to isolate and play back audio from specific speakers. For example, by examining user corrections and adjustments, the platform refines its algorithms over time, ensuring that each subsequent Transcrippet™ becomes more precise. Using the templates, users can rapidly generate new Transcrippets™ by applying predefined styles, layouts, or content structures, which is especially helpful for those who produce frequent or high-volume content.

To maintain cohesive branding and ensure proper licensing, the system 5 integrates with digital asset management (DAM) tools, enabling quick and straightforward access to approved media assets. Users can embed these assets directly into Transcrippets™, adhering to established brand standards and compliance requirements. Furthermore, the system 5 accommodates multi-speaker Transcrippets™ by visually distinguishing among different contributors in the text, such as color highlighting, font changes, etc. or the like. It also supports segment isolation, allowing users to play audio from a single speaker while easily switching to another. This feature provides clarity and organization for panel discussions, interviews, or any scenario involving multiple voices.

The system 5 incorporates advanced audio editing tools within the Transcrippet™ creation interface, allowing users to trim segments, adjust volume levels, and seamlessly splice multiple clips. These features enable the creation of fully customized Transcrippets™ that blend various snippets into a single, coherent piece of content. In addition, the system supports variable playback speeds without altering pitch, letting users accelerate or slow down audio for quick reviews or in-depth analysis. This flexibility ensures that Transcrippets™ cater to diverse needs, from fast-paced content scanning to detailed study.

In some cases, the system 5 may offer integration with e-learning platforms. This integration may allow educators to easily incorporate Transcrippets™ into online courses or learning management systems, enhancing the multimedia capabilities of these educational tools. The system 5 may provide options for creating Transcrippets™ with chapter markers or timestamps. These features may allow users to quickly navigate to specific points within longer audio segments, enhancing the usability of Transcrippets™ created from extended recordings. Additionally, Transcrippets™ may be used by students to transcribe lectures and then allow for detailed playback for the student when reviewing the information.

In some implementations, the system 5 may offer advanced privacy controls for Transcrippets™. These may include options to password-protect Transcrippets™, set expiration dates for shared content, or restrict access to specific users or groups. The system 5 may provide options for creating Transcrippets™ with multiple audio tracks. This feature may allow users to create Transcrippets™ with background music, sound effects, or alternate language tracks, enhancing the versatility and engagement potential of the content. In some cases, the system 5 may offer integration with content recommendation engines, such as via Facebook™, LinkedIn™, etc. This integration may allow websites or platforms that embed Transcrippets™ to suggest related content to users, potentially increasing engagement and time spent on the platform.

The system 5 offers highly interactive transcripts within Transcrippets™, enabling users to click on any specific word in the transcript and instantly jump to that point in the audio playback. This immediate synchronization between text and audio greatly improves navigation and usability, making it far simpler to locate, reference, or revisit particular segments of the recording. In addition, creators can incorporate timestamps, bookmarks, or even speaker-based navigation, further enhancing the precision and speed with which users can find the exact content they need.

To enrich the text presentation, the system 5 provides advanced formatting capabilities that go beyond standard transcription features. Users can apply emphasis with bold or italic text, insert headings or subheadings, create ordered or unordered lists, and set up tables for structured data. Hyperlinks can be embedded within the transcript to direct audiences to related articles, external resources, or supplemental media, transforming Transcrippets™ into a dynamic, knowledge-sharing tool. This advanced formatting not only adds depth to the user experience but also boosts discoverability and context, particularly when Transcrippets™ are shared on websites or social platforms.

The system 5 further supports customizable player skins, enabling extensive control over the visual design of each Transcrippet™. Users can adjust color palettes, fonts, icons, and other interface elements to align perfectly with brand guidelines, website aesthetics, or thematic requirements. Additional customization options might include integrating logos, applying animations or transitions, and incorporating interactive audio waveforms for a modern, engaging look. This level of personalization allows individuals or organizations to maintain a cohesive brand presence across various channels and maximize audience engagement.

As part of the broader functionality, creators can choose to implement accessibility and privacy features alongside these customizations, ensuring that Transcrippets™ comply with diverse organizational policies and user needs. Built-in analytics may track how audiences interact with the formatted text, link clicks, and player interface usage, providing actionable insights for content optimization.

In some examples, the system 5 integrates seamlessly with voice assistants and smart speakers (e.g., Alexa™, Siri™, or the like), enabling users to interact with Transcrippets™ through simple voice commands. This functionality not only improves accessibility—particularly for individuals who prefer hands-free navigation—but also opens a wide range of use cases, such as listening to Transcrippets™ while performing other tasks or controlling playback via smart home devices. For instance, users can request specific Transcrippets™ by title, jump to sections, or pause and resume audio, all without relying on a screen-based interface.

Beyond standard transcription features, the platform uses advanced natural language processing techniques to create automatic content summaries of longer audio segments. These concise overviews capture key points or themes, offering a quick way to gauge whether a listener should dive into the full-length content. Summaries can appear as brief paragraphs, bullet-point lists, or highlighted quotes, further enhancing the flexibility of how information is presented and consumed.

In some examples, users can distribute only the most relevant segments, define custom start and end points for targeted sharing, or compile multiple Transcrippets™ into a playlist that can be easily shared with colleagues, clients, or social media audiences. The system 5 can generate unique links or embed codes for each curated segment or playlist, making it straightforward to integrate Transcrippets™ into websites, marketing campaigns, or collaborative platforms.

The system 5 allows creators to embed interactive quizzes or polls directly within Transcrippets™, transforming passive audio experiences into active learning or feedback opportunities. Content producers can include multiple-choice or open-ended questions, gather audience responses, and even display real-time polling results. By integrating these interactive elements, the platform fosters greater engagement and provides valuable insights into listener preferences or comprehension, making it suitable for educational modules, training programs, and audience-driven marketing campaigns.

In scenarios where authenticity is crucial—such as legal proceedings, academic references, or media verification—the system 5 integrates with blockchain technology to produce verifiable Transcrippets™. This feature leverages immutable, distributed ledger capabilities to record and confirm the authenticity of audio content, thereby reducing the risk of manipulation or tampering. Organizations can use this functionality to validate quotes, testimonies, or any authoritative statements, bolstering trust and credibility in the shared material.

Moreover, the system 5 supports dynamic content for Transcrippets™, enabling real-time updates derived from external data sources. Users can stream constantly evolving information—such as stock market fluctuations, breaking news, or live sports results—into their Transcrippets™, ensuring that listeners always have the most current details. This real-time capability is especially useful for news organizations, financial analysts, and other fields that demand prompt dissemination of up-to-date data.

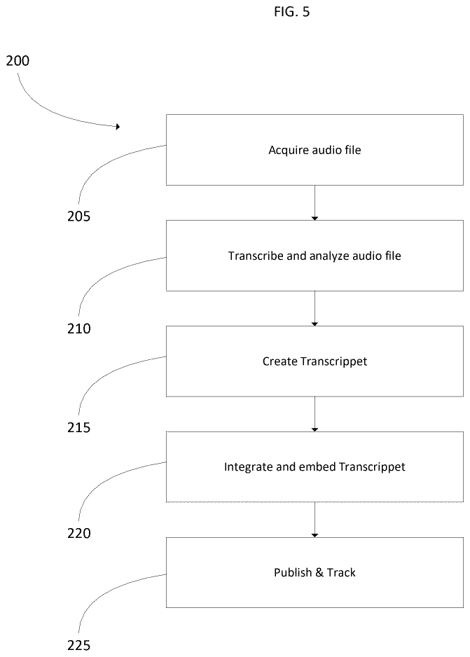

FIG. 5 is a flowchart of a process describing the generation and use of Transcrippets™. The process begins at step 205, where users acquire or upload an audio source needed for Transcrippets™ creation, such as via the user interface 50 and/or user device 30. The audio source may be received by the server 10 or otherwise transmitted to the server 10. For example, audio may be captured from a live event, select an existing recording, or pull from an integrated media library. By gathering the required audio at the outset, the system 5 establishes the foundation for all subsequent operations, from transcription to customization. Once the audio is available, the system 5 automatically transcribes it using speech-to-text algorithms, at step 210. Depending on user settings, advanced features such as noise reduction, speaker diarization, or multi-language translation can be applied to enhance quality and clarity. During this stage, the system may also perform content analysis—identifying themes, sentiments, or keywords—to help users understand and organize the audio more effectively.

The process includes step 215, where users edit and customize their Transcrippets™, after the audio has been transcribed. Users can delete unwanted sections, splice together multiple clips, and/or highlight specific parts of the audio transcription that best convey the intended message. The system 5 additionally offers branding and styling options—such as font selection, color schemes, and interactive elements—to ensure that each Transcrippet™ aligns with the user's aesthetic requirements and engagement goals. At step 220, users integrate Transcrippets™ into websites, social platforms, and/or other digital environments. The system 5 typically generates unique embed codes or supports direct publishing to compatible content management systems for seamless placement. This step can include attaching relevant metadata or tags, making it easier for audiences to discover and interact with the Transcrippets™ across various platforms.

At step 225, users publish (e.g., embed within a web interface or document), share, and/or continuously refine their Transcrippets™. For example, a user may choose to publish the content immediately or schedule future publication times for targeted promotions. Once published, analytics features track engagement and feedback, allowing users to gauge effectiveness and make iterative improvements. For example, a user may make improvements such as updating transcripts, enhancing interactive elements, or adjusting distribution strategies to optimize audience reach and content impact. A user may choose to track various usage metrics for the Transcrippet™. These metrics include, for example, total play counts, average listening duration, completion rates, the number of unique visitors, device type, geographic location, or time of day. In some examples, the Transcrippets™ may leverage this feedback to refine the Transcrippets™. For instance, where users of the Transcrippets™ frequently drop off at a particular time stamp, the transcription module 105 might condense or reorganize the Transcrippet™ to hold the interest of a user. In some examples, if a certain speaker or topic garners unusually high engagement, future content can emphasize similar visual or audio elements. In addition, iterative improvements might involve updating the transcript for greater clarity, embedding quizzes or polls to enable interaction between the Transcrippets™ and the user, or targeting different distribution channels. For example, newsletter platforms, social media communities, or partner websites may be incorporated by the transcription module 105 to broaden reach and appeal of the Transcrippets™. This cyclical process of publishing, monitoring, analyzing, and refining ensures that Transcrippets™ remain dynamic, relevant, and tuned to audience preferences.

As detailed in FIGS. 1-5, the system 5 enables users to create and share Transcrippets™ directly from recorded and transcribed audio within the platform, via the user interface 50. Transcrippets™ are automatically generated, by the electronic processor of the server, for a variety of audio content, ranging from pre-recorded interviews and podcasts to lectures and presentations. In addition, the transcription module 105 supports the creation of Transcrippets™ from live audio streams, allowing users to produce and share these audio-text snippets in real time during events such as earnings calls, press conferences, or live broadcasts.

Several implementations have been described. Nevertheless, it will be understood that various modifications may be made without departing from the spirit and scope of the disclosure. Accordingly, other implementations are within the scope of the following claims.

1. A system for embedding transcribed audio in a document, comprising:
a user device including a user device electronic processor, the user device electronic processor configured to generate a user interface;
a server including a server-side electronic processor and a memory storing computer-executable instructions that define an algorithm for managing audio-text synchronization, the server-side electronic processor communicatively coupled to the server, the user device, and the memory;
wherein the server is configured to store audio data and transcribed text, and the server-side electronic processor is configured to execute the stored algorithm configured to:
transmit, to the user device electronic processor, transcribed text and audio data including a transcribed text and a corresponding audio segment,
generate, on the user device, via the user device electronic processor, a user interface configured to display the transcribed text;
enable, via the user device electronic processor, a selection mechanism through which a user selects a portion of the transcribed text;
synchronize, via an audio processing unit, the selected portion of the transcribed text with the corresponding audio segment;
generate, via an embedding module, shareable content that combines the selected portion of the transcribed text and the corresponding audio segment; and
display, on the user interface of the user device, the shareable content.

2. The system of claim 1, wherein the user interface is configured to display the transcribed text and corresponding audio waveform.

3. The system of claim 1, wherein the selection mechanism is configured to allow the user to select the portion of the transcribed text by highlighting text or specifying start and end points.

4. The system of claim 1, wherein the audio processing unit is configured to extract the corresponding audio segment based on timestamps associated with the selected portion of the transcribed text.

5. The system of claim 1, wherein the embedding module includes an embedding functionality configured to generate an embeddable code snippet for inserting the shareable content into a web page or document.

6. The system of claim 5, wherein the embeddable code snippet includes a script for rendering an interactive player displaying the selected portion of the transcribed text and controls for playing the corresponding audio segment.

7. The system of claim 6, wherein the interactive player is configured to highlight words in the displayed transcribed text as they are spoken in an audio playback.

8. A method for embedding transcribed audio in a document, comprising:
storing, in a server memory accessible by a server-side electronic processor, audio data and transcribed text corresponding to the audio data;
communicating, from the server-side electronic processor to a user device electronic processor, the transcribed text and corresponding audio data;
providing, on the user device, via the user device electronic processor, a user interface configured to display the transcribed text;
receiving, via the user interface, a user selection of a portion of the transcribed text;
synchronizing, via an audio processing unit, the selected portion of the transcribed text with a corresponding audio segment;
generating, via an embedding module, shareable content that combines the selected portion of the transcribed text and the corresponding audio segment; and
displaying, on the user interface of the user device, the shareable content.

9. The method of claim 8, further comprising displaying a waveform representation of the audio segment alongside the transcribed text in the user interface.

10. The method of claim 8, wherein receiving the user selection comprises detecting a highlighting action performed by the user on the transcribed text.

11. The method of claim 8, wherein synchronizing the selected portion of the transcribed text with the corresponding audio segment comprises:
identifying timestamps associated with the selected portion of the transcribed text; and
extracting the corresponding audio segment based on the identified timestamps.

12. The method of claim 8, wherein generating the shareable content comprises creating an embeddable code snippet for inserting the shareable content into a web page or document.

13. The method of claim 12, wherein the embeddable code snippet includes JavaScript for rendering an interactive player displaying the selected portion of the transcribed text and controls for playing the corresponding audio segment.

14. The method of claim 13, wherein the interactive player is configured to highlight words in the displayed transcribed text as they are spoken during playback of the corresponding audio segment.

15. A non-transitory computer-readable medium storing instructions that, when executed by one or more processors, cause the one or more processors to perform operations for embedding transcribed audio in a document, the operations comprising:
storing, in a server memory accessible by a server-side electronic processor, audio data and corresponding transcribed text;
communicating, from the server-side electronic processor to a user device electronic processor, the transcribed text and the corresponding audio data;
providing, via the user device electronic processor, a user interface on the user device, wherein the user interface is configured to display the transcribed text;
receiving, via the user interface, a user selection of a portion of the transcribed text;
synchronizing, via an audio processing unit, the selected portion of the transcribed text with a corresponding audio segment;
generating, via an embedding module, shareable content that combines the selected portion of the transcribed text with the corresponding audio segment; and
displaying, on the user interface of the user device, the shareable content.

16. The non-transitory computer-readable medium of claim 15, wherein the operations further comprise displaying a waveform representation of the audio segment alongside the transcribed text in the user interface.

17. The non-transitory computer-readable medium of claim 15, wherein receiving the user selection comprises detecting a highlighting action performed by the user on the transcribed text.

18. The non-transitory computer-readable medium of claim 15, wherein synchronizing the selected portion of the transcribed text with the corresponding audio segment comprises:
identifying timestamps associated with the selected portion of the transcribed text; and
extracting the corresponding audio segment based on the identified timestamps.

19. The non-transitory computer-readable medium of claim 15, wherein generating the shareable content comprises creating an embeddable code snippet for inserting the shareable content into a web page or document.

20. The non-transitory computer-readable medium of claim 19, wherein the embeddable code snippet includes a code for rendering an interactive player displaying the selected portion of the transcribed text and controls for playing the corresponding audio segment, and wherein the interactive player is configured to highlight words in the displayed transcribed text as they are spoken during playback of the corresponding audio segment.
